(19) United States
(12) Patent Application Publication
(10) Pub. No.: US 2015/0317976 A1
(43) Pub. Date: Nov. 5, 2015

(54) SYSTEM AND METHOD FOR CREATING MYSTORE VIDEO RECORDINGS AND EMBEDDED TEXT

(71) Applicant: Todd Meagher, Keller, TX (US)

(72) Inventor: Todd Meagher, Keller, TX (US)

(21) Appl. No.: 14/797,174

(22) Filed: Jul. 12, 2015

(51) Int. Cl. G10L 15/26; G10L 15/08

(52) U.S. Cl. CPC G10L 15/26; G10L 15/08

(57) ABSTRACT

A system for creating mystore video recordings with embedded text is provided. The system comprises a mobile device with video recording functionality and voice recognition functionality and an application stored on the mobile device. When executed on the mobile device, the application recognizes a first spoken keyword during recording of a first video and stores a first utterance, the first utterance spoken immediately following the first spoken keyword. The application further recognizes a second spoken keyword during recording of the first video and stores a second utterance, the second utterance spoken immediately following the second spoken keyword. The application further converts the first utterance to a first text string, converts the second utterance to a second text string, and embeds the first text string and the second text string into the first video.

### CROSS REFERENCE TO RELATED APPLICATIONS

None

### FIELD OF THE DISCLOSURE

The present disclosure is in the field of telecommunications services. More particularly, the present disclosure is in the technical fields of wireless devices and services for creating specialized video content containing embedded media.

### BACKGROUND OF THE DISCLOSURE

Individuals, firms, institutions, and other entities may seek to widely distribute information about goods available for sale. Likelihood of locating buyers and consummating sales is increased with a wider distribution of information as well as more descriptive and timely information about available goods. Sellers seek to manage costs of generating and distributing information about available goods. Sellers further seek to simplify transaction processes for completing sales.

Persons seeking to dispose of household property and organizations seeking to liquidate inventory and capital assets often publish information about available goods in newsletters, circulars, flyers and pamphlets. Such hard copy materials are often made available free of charge and may be found in public areas and other high traffic areas such as retail locations. Printed material also may mailed in bulk distribution via postal mail. Such wide distribution methods may be expensive based on printing, physical delivery and mailing costs and are wasteful and harmful to the environment. Information in printed material may become out of date quickly, rendering the printed material of no further use, necessitating disposal and replacement with additional printed material.

### SUMMARY OF THE DISCLOSURE

In embodiment, a system for creating mystore video recordings with embedded text is provided. The system comprises a mobile device with video recording functionality and voice recognition functionality and an application stored on the mobile device. When executed on the mobile device, the application recognizes a first spoken keyword during recording of a first video and stores a first utterance, the first utterance spoken immediately following the first spoken keyword. The application further recognizes a second spoken keyword during recording of the first video and stores a second utterance, the second utterance spoken immediately following the second spoken keyword. The application further converts the first utterance to a first text string, converts the second utterance to a second text string, and embeds the first text string and the second text string into the first video.

In an embodiment, a method of creating mystore video recordings with embedded text is provided. The method comprises a computer receiving a message containing a video file, the video file containing at least one embedded text string. The method further comprises the computer embedding a selectable object into the video file wherein the selectable object is persistently displayed and selectable during playing of the video file. The method further comprises the computer linking the selectable object to an electronic transaction function and posting the video file to an online electronic commerce venue.

In an embodiment, another method of creating mystore video recordings with embedded text is provided. The method comprises a mobile device activating a locally executing video camera application and a locally executing voice recognition application. The method further comprises the mobile device recording at least one pair of spoken sounds comprising a preconfigured keyword and an immediately following vocal expression, The method further comprises the mobile device converting the at least one pair of spoken sounds to an at least first text string. The method further comprises the mobile device embedding the at least first text string into a file containing a video recorded while the at least one pair of sounds were spoken.

### BRIEF DESCRIPTION OF THE DRAWINGS

FIG. 1 depicts a block diagram of a system for creating MyStore video recordings with embedded text in accordance with an embodiment of the present disclosure.

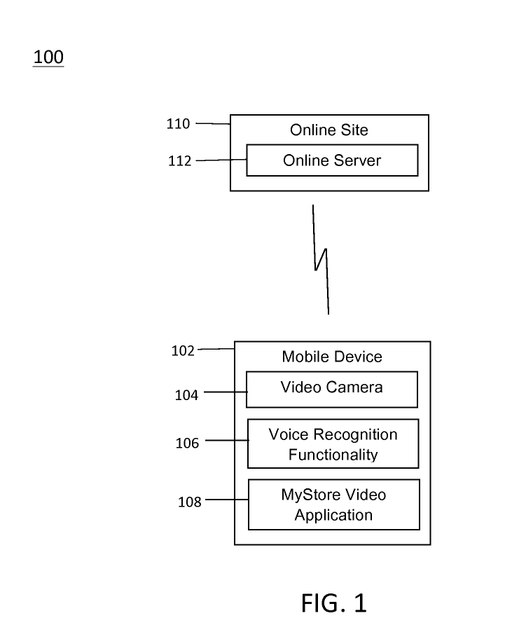

FIG. 2 depicts a flowchart of a method for creating MyStore video recordings with embedded text in accordance with an embodiment of the present disclosure.

FIG. 3 depicts a flowchart of another method for creating MyStore video recordings with embedded text in accordance with an embodiment of the present disclosure.

### DETAILED DESCRIPTION OF THE INVENTION

Systems and methods provided herein enable a handheld mobile device to recognize spoken keywords while creating video content and to thereafter insert readable text into the video based on the keywords. The keywords indicate labels such that words and numbers spoken immediately after the keywords are recorded, converted to text, placed into the video stream, and displayed during playing of the video.

An application is provided that executes on the mobile device, such as a smartphone, wherein the device includes voice recognition and video recording functionality. The application is configured to recognize certain keywords spoken by the mobile device user during recording of video content. When a preconfigured keyword is spoken by the user and recognized by the application, the application then records words and numbers spoken by the user immediately following the recognized keyword. The application converts the recorded words and numbers to text and displays the text during playing of the video. The text is displayed at the point in the video where the mobile device user spoke the words and numbers following the keyword.

In an embodiment, the mobile device user may wish to sell certain items in an online store, such as an electronic commerce site on the Internet or other widely accessible electronic venue. Using a mobile device such as a smartphone configured as provided herein, the user starts the application and begins a video recording. The application may be configured to recognize spoken keywords such as “item”, “quantity”, and “price.”

When the user speaks these keywords during recording of the video, the application records spoken utterances immediately following the keywords. The spoken utterances, and in some cases the keywords, are converted to text and inserted into the video. The text is displayed at the point in the video that a viewer would be seeing the items for sale.

The video may be posted to an online site for buying and selling items of the type the mobile device user wishes to sell. A selectable “buy” button may be inserted into the video that an online viewer may activate to purchase the items depicted in the video and described in the inserted and displayed text. Activating the buy button connects the viewer to secure payment functionality facilitating purchase or other desired transaction via credit or debit card or bank account draft.

The systems and methods provided herein may be used by an individual user of the mobile device seeking to dispose of household items for cash, for example prior to relocation. A dealer of previously owned automobiles or boats or used farming, construction or industrial equipment may use the application to make online sales. A retailer or other vendor of goods in an inventory liquidation or bankruptcy situation may dispose of goods using the described systems and methods. A judicial, law enforcement, or government body seeking to liquidate property seized during legal actions, for example vehicles, aircraft, computer equipment, and firearms, may do so by creating and posting video content as described herein.

Turning to the figures, a system 100 of a MyStore Video application is provided. The system 100 comprises a mobile device 102. The mobile device 102 comprises a video camera 104, voice recognition functionality 106, and a MyStore Video application 108, hereinafter referred to as the “application 108” for ease of discussion. The system 100 also comprises an online site 110 and an online server 112.

The mobile device 102 may be a mobile telephone hosting an advanced operating system providing significant computing and communications capabilities. The mobile device 102 may be a smartphone that can download a plurality of applications or “apps” that execute fully or partially on the mobile device 102.

The application 108 may be downloadable and executes on the mobile device 102. The application 108 allows a user of the mobile device 102 to create a video recording of objects and embed readable text via voice command into the video stream that a viewer sees while watching the video. The application 108 may be configurable with certain keywords such that when a configured keyword is spoken while the video camera 104 is recording, the application 108 recognizes the user's intention to create text for insertion.

The keyword is effectively a label for a user utterance or vocal expression of words and/or numbers that will immediately follow the keyword. The application 108 records the keyword spoken and the user utterance that follows. In an embodiment, the user may speak a plurality of pairs of preconfigured keywords and accompanying utterances that the application 108 records during creation of a video for later placement as text in the stream of the completed video.

When the user is finished recording the video, the application 108 converts the recorded utterances into text strings. In some cases the preceding keywords, which serve as viewable labels for the utterances when displayed, are also converted to text for insertion into an electronic file containing the video. The application 108 then inserts the text strings including labels where applicable, into the stream of the video at the points where the keywords and accompanying utterances were spoken.

In an exemplary embodiment, a user of the mobile device 102 may wish to sell several used household items, for example a window air conditioner, a pool table, and a wall mirror. The user starts the application 108 which would automatically assure that both the video camera 104 and voice recognition functionality 106 resident on the mobile device 102 are activated. In the event the application 108 cannot activate the video camera 104 and voice recognition functionality 106 for any reason, the application 108 may provide a visual or audible message requesting their activation.

As the user in the exemplary embodiment is moving about his home creating the video of the items he wishes to sell, he calls out preconfigured keywords. As he films the window air conditioner from several perspectives to show that it is in good condition, he calls out the keyword “item” followed by the utterance “window air conditioner.” Later while still filming the air conditioner, the user calls out the keyword “price” followed by the words “one hundred dollars.” Thereafter the user calls out the keyword “quantity” followed by the word “one.”

The spoken and recorded words “item”, “price”, and “quantity” are recognized by application 108 as previously configured keywords. Therefore, utterances immediately following these keywords are recorded. Hence, the words “window air conditioner”, “one hundred dollars” and “one” are also recorded after their respective preceding keywords are recognized by the application 108. The user similarly follows these steps for the pool table, wall mirror, and any other items he may decide he wishes to sell.

When finished recording his video, the user calls out the keyword “done” whereupon the application 108 may display each of the keywords and accompanying recorded utterances for the user to view and correct if necessary. Thereafter, the video is ready for posting.

The system 100 also comprises the online site 110 and the online server 112. The online site 110 may be a widely accessible electronic venue that interested parties may use to view and purchase items for sale. The online site 110 may be a web site on the world wide web of the public Internet or it may be a site on a private intranet with access limited to select parties. The online site 110 may alternatively not be on a computer-accessible data network and may instead be accessible via cable or closed circuit television wherein interested parties use remote handheld devices to control their televisions. The online server 112 is a computer that hosts all or part of the video for the online site 110.

Once the user of the mobile device 102 is finished reviewing the video he/she has created, the video may be posted to the online site 110 where it is stored in the online server 112, which may be a generic computer. The online site 110 places a “buy” button into the video stream near each of the objects depicted in the video shortly after the text strings for each particular object or set of objects offered for sale are depicted. The online site 110 links each buy button to a secure payment function that processes viewers' payments for items they wish to purchase. The online site 110 may insert information into the video that supplements the text that has been inserted using the components and actions taught herein. The online site 110 also consummates other arrangements regarding shipping and freight where applicable.

After the user of the mobile device 102 posts the finished video to the online site 110, the user may thereafter log into the online site 110 using secure credentials. The user may then modify some of the text content previously entered into his posted video and may add content.

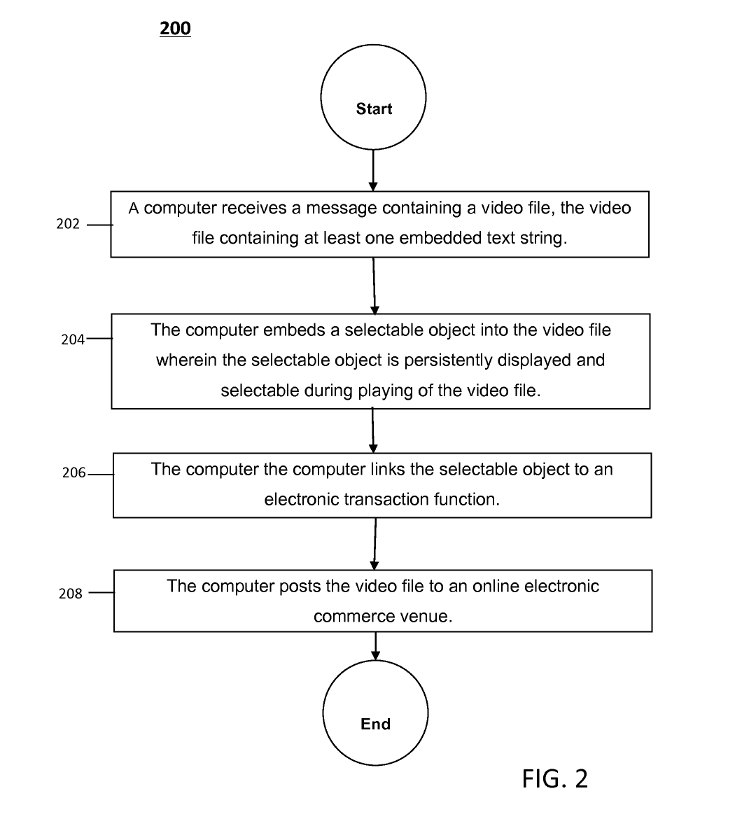

Turning to FIG. 2, a method 200 of creating mystore video recordings with embedded text is provided. Beginning at block 202, a computer receives a message containing a video file, the video file containing at least one embedded text string. At block 204, the computer embeds a selectable object into the video file wherein the selectable object is persistently displayed and selectable during playing of the video file. At block 206, the computer links the selectable object to an electronic transaction function. At block 208, the computer posts the video file to an online electronic commerce venue. The method 200 terminates thereafter.

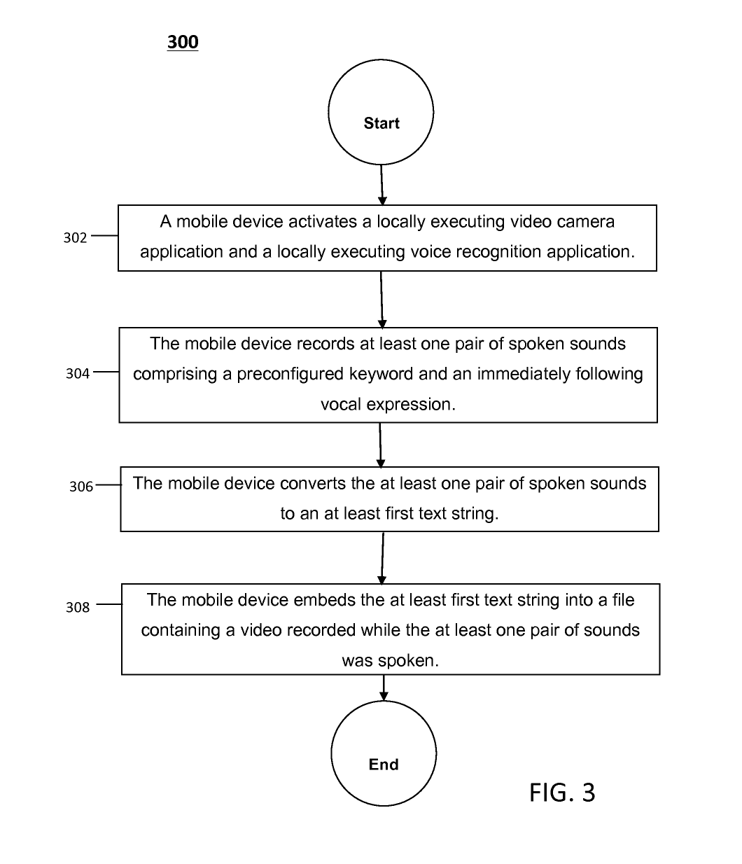

Turning to FIG. 3, a method 300 of creating mystore video recordings with embedded text is provided. Beginning at block 302, a mobile device activates a locally executing video camera application and a locally executing voice recognition application. At block 304, the mobile device records at least one pair of spoken sounds comprising a preconfigured keyword and an immediately following vocal expression. At block 306, the mobile device converts the at least one pair of spoken sounds to an at least first text string. At block 308, the mobile device embeds the at least first text string into a file containing a video recorded while the at least one pair of sounds was spoken. The method 300 terminates thereafter.

As noted, the online server 112 may be a general purpose computer. Such a general purpose computer comprises at least a processor or central processing unit (CPU), read-only memory, random access memory, data storage, and input/output devices. A general purpose computer may also comprise network interface cards (NIC) to communicate on a local area network (LAN) and other hardware promoting communication over wide area networks and the Internet.

Although the above descriptions set forth preferred embodiments, it will be understood that there is no intent to limit the embodiment of the disclosure by such disclosure, but rather, it is intended to cover all modifications, substitutions, and alternate implementations falling within the spirit and scope of the embodiment of the disclosure. The embodiments are intended to cover capabilities and concepts whether they be via a loosely coupled set of components or they converge into one or more integrated components, devices, circuits, and/or software programs.

What is claimed is:

1. A system for creating mystore video recordings with embedded text, comprising:
a mobile device with video recording functionality and voice recognition functionality, and
an application stored on the mobile device that, when executed on the mobile device:
recognizes a first spoken keyword during recording of a first video,
stores a first utterance, the first utterance spoken immediately following the first spoken keyword,
recognizes a second spoken keyword during recording of the first video,
stores a second utterance, the second utterance spoken immediately following the second spoken keyword,
converts the first utterance to a first text string,
converts the second utterance to a second text string, and
embeds the first text string and the second text string into the first video.

2. The system of claim 1, wherein the first text string and the second text string are displayed during replay of the first video.

3. The system of claim 1, wherein the first spoken keyword and the second spoken keyword indicate labels for the first text string and the second text string, respectively.

4. The system of claim 3, wherein the labels are displayed in text format with corresponding text strings during replay of the first video.

5. The system of claim 4, wherein the labels and the corresponding text strings are displayed at points during replay of the first video at which they were recorded.

6. The system of claim 1, wherein the first utterance and the second utterance describe at least one object displayed in the first video.

7. The system of claim 1, wherein the first video, when completed, is posted on a widely viewable online site, and is embedded with a selectable button that when selected triggers a transaction for the at least one object.

8. A method of creating mystore video recordings with embedded text, comprising:
a computer receiving a message containing a video file, the video file containing at least one embedded text string;
the computer embedding a selectable object into the video file wherein the selectable object is persistently displayed and selectable during playing of the video file;
the computer linking the selectable object to an electronic transaction function; and
the computer posting the video file to an online electronic commerce venue.

9. The method of claim 8, wherein the video file depicts at least one item offered via the electronic commerce venue.

10. The method of claim 8, wherein the at least one embedded text string is displayed and readable during viewing of the video file.

11. The method of claim 9, wherein the at least one embedded text string at least one of identifies and provides at least one of price and quantity information for the at least one item offered.

12. The method of claim 9, wherein the selectable object, when activated, initiates an electronic transaction for the at least one depicted item.

13. The method of claim 8, wherein the message is received from a mobile device that created the video file.

14. The method of claim 8, wherein the at least one text string is embedded into the video file by an application executing on the mobile device.

15. The method of claim 8, wherein the at least one text string is converted from at least one utterance spoken during creation of the video file.

16. A method of creating mystore video recordings with embedded text, comprising:
a mobile device activating a locally executing video camera application and a locally executing voice recognition application;
the mobile device recording at least one pair of spoken sounds comprising a preconfigured keyword and an immediately following vocal expression;
the mobile device converting the at least one pair of spoken sounds to an at least first text string; and
the mobile device embedding the at least first text string into a file containing a video recorded while the at least one pair of sounds were spoken.

17. The method of claim 17, wherein the text string is displayed during playing of the file containing the video.

18. The method of claim 17, wherein the text string is displayed at a point in the video at which the at least first pair of sounds were spoken.

19. The method of claim 18, wherein the at least first pair of spoken sounds describes at least one object recorded by the mobile device at the point in the video at which the at least first pair of sounds were spoken.

20. The method of claim 16, wherein the at least first pair of spoken sounds comprises at least a first preconfigured keyword representing a label for an item of information about the at least one object and further comprises at least a first vocal expression of the item of information, the at least first vocal expression immediately following the at least first preconfigured keyword.
